(19) United States
(12) Patent Application Publication
(10) Pub. No.: US 2006/0036952 A1
(43) Pub. Date: Feb. 16, 2006

(54) Program-controlled system startup management interface for computer platform

(75) Inventor: Ji-Chi Yang, Taipei (TW)

Correspondence Address: Mr. Peter F. Corless;EDWARDS & ANGELL, LLP, 101 Federal Street, Boston, MA, 02110, US

(73) Assignee: Inventec Corporation

(21) Appl. No.: 10/920,088

(22) Filed: Aug. 16, 2004

(51) Int. Cl. G06F 17/00

(52) U.S. Cl. 715/741

(57) ABSTRACT

A program-controlled system startup management interface for computer platform is proposed, which is designed for use with a computer platform, such as a network server, for providing a user-operated program-controlled system startup procedure for the user to start up or shut down the computer platform, and which is characterized by the use of a program-controlled procedure which includes a user-authorization step to check whether the user (who intend to start up or shut down the computer platform) is authorized to do so. This feature can help prevent the computer platform from being inadvertently turned on or off, and can also help prevent the computer platform from being turned off by ill-intended persons.

### BACKGROUND OF THE INVENTION

1. Field of the Invention

This invention relates to computer technology, and more particularly, to a program-controlled system startup management interface for use with a computer platform, such as a network server (including blade server), a network workstation, a desktop computer, or the like, for providing a user-operated program-controlled system startup function for the user to start up or shut down the computer platform.

2. Description of Related Art

Network servers are computer platforms that are linked to a network systems for providing various kinds of data service functions, such as serving Web pages, sharing files and data, and so on, among client workstations over the networks. Since Internet has become widely used and indispensable in all kinds of trades, server management is an important part of network management in this information age.

One important task in server management is the startup and shutdown of a server unit, which includes power-on, power-off, and reset. Presently, the server unit is typically equipped with a power button and a reset button on the outer casing. The power button allows the management personnel to switch on or off the power of the server unit; and in the event of a system crash to the server unit, the crashed server unit can be rebooted back to normal operation simply by pressing the reset button.

One drawback to the use of power button and reset button on server unit, however, is that they can be easily inadvertently touched by any persons working nearby, thus accidentally causing the server unit to be turned off or undergo an unintended reboot procedure that would temporarily interrupt its server functions over the network.

Moreover, still another drawback to the use of power button and reset button on server unit is that it would allow any ill-intentioned persons to easily interrupt the operation of the server unit simply by pressing the power button or reset button to shut down the server unit.

### SUMMARY OF THE INVENTION

It is therefore an objective of this invention to provide a program-controlled system startup management interface that allows the startup and shutdown of a computer platform to be program-controlled by authorized personnel, rather than button-controlled, so as to prevent the computer platform from being inadvertently or ill-intentionally turned off.

It is another objective of this invention to provide a program-controlled system startup management interface that allows only authorized personnel to start up or shut down a computer platform.

The program-controlled system startup management interface according to the invention is designed for use with a computer platform, such as network server (including blade server), network workstation, desktop computer, and the like, for providing a user-operated program-controlled system startup procedure for the user to start up the computer platform.

The program-controlled system startup management interface according to the invention is characterized by the use of a program-controlled procedure which includes a user-authorization step to check whether the user (who intend to start up or shut down the computer platform) is authorized to do so. This feature can help prevent the computer platform from being inadvertently turned on or off, and can also help prevent the computer platform from being turned off by ill-intended persons.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized component model of the program-controlled system startup management interface for computer platform according to the invention;

FIG. 2A is a schematic diagram showing a user login interface provided by the program-controlled system startup management interface of the invention during operation;

FIG. 2B is a schematic diagram showing an operation mode selection interface provided by the program-controlled system startup management interface of the invention during operation; and

FIG. 2C is a schematic diagram showing an operating system selection interface provided by the program-controlled system startup management interface of the invention during operation.

### DETAILED DESCRIPTION OF PREFERRED EMBODIMENTS

The inv according to the invention is disclosed in full details by way of preferred embodiments in the following with reference to the accompanying drawings.

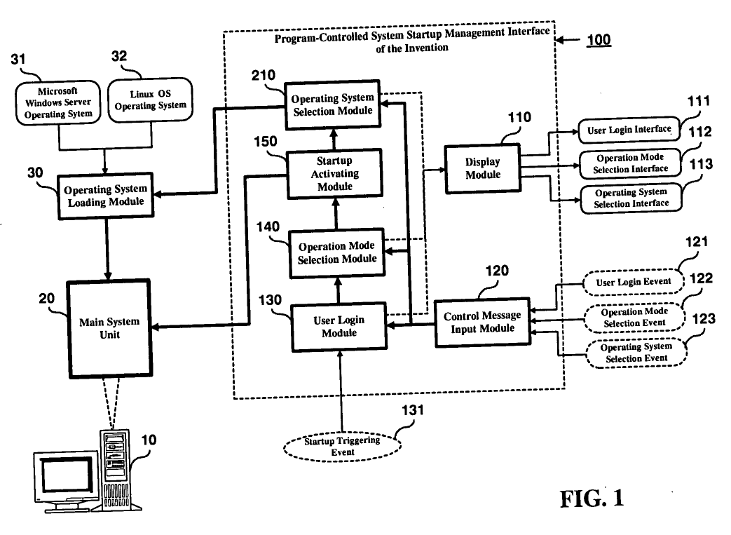

FIG. 1 is a schematic diagram showing the application architecture and object-oriented component model of the program-controlled system startup management interface for computer platform according to the invention (as the part enclosed in the dotted box indicated by the reference numeral 100). As shown, the program-controlled system startup management interface of the invention 100 is designed for use with a computer platform 10, such as a network server (including blade server), a network workstation, a desktop computer, and the like, for providing a user-operated program-controlled system startup function for the computer platform 10.

The object-oriented component model of the program-controlled system startup management interface of the invention 100 comprises: (a) a display module 110; (b) a control message input module 120; (c) a user login module 130; (d) an operation mode selection module 140; and (e) a startup activating module 150; and can further optionally include an operating system selection module 210.

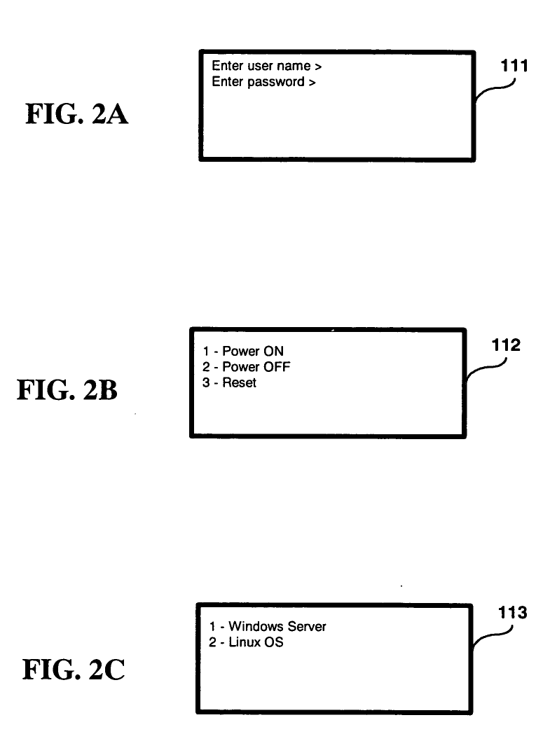

The display module 110 is, for example, a small-size LCD (Liquid Crystal Display) unit, which is used to display a set of user-machine interactive interfaces, including, for example, a user login interface 111 shown in FIG. 2A, an operation mode selection interface 112 shown in FIG. 2B, and an operating system selection interface 113 shown in FIG. 2C.

The control message input module 120 is, for example, a small-size matrix keyboard, which serves as an input interface for the user to input a set of user-authorization data (i.e., username and password), select desired operation mode, and select desired operating system.

The user login module 130 is capable of being activated in response to a startup triggering event 131 (for example when the standby power of the computer platform 10 is turned on by the user) to display a user login interface 111 (as shown in FIG. 2A) on the display module 110 for the user to input his/her user-authorization data (for example, username and password). When the user completes the input of his/her username and password, it triggers the occurrence of a user login event 121 that causes the control message input module 120 to responsively receive the user-input authorization data and check whether the user-input authorization data are valid or not. If NOT, the user login module 130 will disallow the user to perform a startup procedure on the computer platform 10; whereas if YES, the user login module 130 will responsively issue a startup management enabling message to the operation mode selection module 140.

The operation mode selection module 140 is capable of being activated in response to the startup management enabling message from the control message input module 130 to display an operation mode selection interface 112 (as shown in FIG. 2B) through the display module 110, showing a list of operation mode options including, for example, a “Power ON” option, a “Power OFF” option, and a “Reset” option. The user can then utilize the control message input module 120 (i.e., matrix keyboard) to select his/her desired operation mode. When the user completes his/her selection of desired operation mode, it triggers the occurrence of an operation mode selection event 122 which causes the operation mode selection module 140 to responsively issue a corresponding operation mode enabling message based on the user-selected operation mode. For example, if the user selects “Power ON”, it will cause the operation mode selection module 140 to issue a power-on enabling message to the startup activating module 150; if the user selects “Power OFF”, it will cause the operation mode selection module 140 to issue a power-off enabling message to the startup activating module 150; and if the user selects “Reset”, it will cause the operation mode selection module 140 to issue a reset enabling message to the startup activating module 150.

The startup activating module 150 is capable of being activated in response to each different operation mode enabling message (i.e., power-on enabling message, power-off enabling message, or reset enabling message) from the operation mode selection module 140 to activate the main system unit 20 of the computer platform 10 to undergo a corresponding operational procedure; i.e., in the event of a power-on enabling message, the startup activating module 150 will responsively switch on the power of the main system unit 20 of the computer platform 10; in the event of a power-off enabling message, the startup activating module 150 will responsively switch off the power of the same; and in the event of a reset enabling message, the startup activating module 150 will responsively activate the main system unit 20 of the computer platform 10 to undergo a reset procedure to reboot the computer platform 10. In practical implementation, in the case of the computer platform 10 being a blade serer, for example, the startup activating module 150 can be a BMC (Baseboard Management Controller) based functional unit in an IPMI (Intelligent Platform Management Interface) compliant server management interface that is integrated to the blade server.

The operating system selection module 210 is an optional module that can be additionally integrated to the program-controlled system startup management interface of the invention 100 in the case of two or more different kinds of operating systems being available for installation on the computer platform 10 (if the computer platform 10 utilizes only one kind of operating system, then this operating system selection module 210 is unnecessary). This operating system selection module 210 is capable of being activated in response to a power-on procedure or a reset procedure to display an operating system selection interface 113 (as shown in FIG. 2C) on the display module 110, showing a list of operating system options, including, for example, a Microsoft Windows Server operating system 31 and a Linux OS operating system 32, for the user to select a desired operating system therefrom. The user can then utilize the control message input module 120 (i.e., matrix keyboard) to select the desired operating system. When the user completes his/her selection, it triggers the occurrence of an operating system selection event 123 which causes the operating system selection module 210 to responsively activate a loader module 30 on the computer platform 10 to load the user-selected operating system (i.e., either Microsoft Windows Server operating system 31 or Linux OS operating system 32) into the main system unit 20 of the computer platform 10.

Referring together to FIG. 1 and FIGS. 2A-2C, in actual application, when a user wants to start up the computer platform 10, the user needs first to turn on the program-controlled system startup management interface of the invention 100 and then turn on the standby power of the computer platform 10, which will initiate the occurrence of a startup triggering event 131, causing the user login module 130 to responsively display a user login interface 111 (as shown in FIG. 2A) on the display module 110 for the user to input his/her user-authorization data (i.e., username and password). When the user completes the input of his/her username and password, it initiates the occurrence of a user login event 121, causing the control message input module 120 to responsively receive the user-input authorization data and check whether the user-input authorization data are valid or not. If NOT, the user login module 130 will inhibit the user from performing a startup procedure on the computer platform 10; whereas if YES, the user login module 130 will responsively issue a startup management enabling message to the operation mode selection module 140, causing the operation mode selection module 140 to responsively display an operation mode selection interface 112 (as shown in FIG. 2B) on the display module 110, showing a list of operation mode options including, for example, a “Power ON” option, a “Power OFF” option, and a “Reset” option. The user can then utilize the control message input module 120 (i.e., matrix keyboard) to select the intended operation mode “Power ON”, which will cause the operation mode selection module 140 to issue a power-on enabling message to the startup activating module 150, causing the startup activating module 150 to activate the main system unit 20 of the computer platform 10 to undergo a power-on procedure.

If the computer platform 10 utilizes two or more different kinds of operating systems, then the power-on procedure will trigger the operating system selection module 210 to responsively display an operating system selection interface 113 (as shown in FIG. 2C) on the display module 110, showing a list of operating system options, including, for example, a Microsoft Windows Server operating system 31 and a Linux OS operating system 32, for the user to select a desired operating system therefrom. The user can then utilize the control message input module 120 (i.e., matrix keyboard) to select the desired kind of operating system. When the user completes his/her selection, it triggers the occurrence of an operating system selection event 123, causing the operating system selection module 210 to responsively activate a loader module 30 on the computer platform 10 to load the user-selected operating system (i.e., either Microsoft Windows Server operating system 31 or Linux OS operating system 32) into the main system unit 20 of the computer platform 10, thereby booting the computer platform 10 with the user-selected operating system.

After the computer platform 10 has been successfully started up, if the user wants to reset or shut down the computer platform 10, the user can first activate the program-controlled system startup management interface of the invention 100, and then use the user login module 130 to verify his/her authorization status, and finally use the operation mode selection module 140 to select the “Power OFF” or “Reset” option. This will then cause the startup activating module 150 to command the computer platform 10 to undergo a power-off procedure or a reset procedure.

In conclusion, the invention provides a program-controlled system startup management interface which is designed for use with a computer platform for providing a user-operated program-controlled system startup function for the user to start up or shut down the computer platform, and which is characterized by the use of a program-controlled procedure which includes a user-authorization step to check whether the user (who intend to start up or shut down the computer platform) is authorized to do so. This feature can help prevent the computer platform from being inadvertently turned on or off, and can also help prevent the computer platform from being turned off by ill-intended persons. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A program-controlled system startup management interface for use with a computer platform for providing a user-operated program-controlled system startup management function for the computer platform;
the program-controlled system startup management interface comprising:
a display module, which is used to display a set of user-machine interactive interfaces for user-specified control of the program-controlled system startup management interface;
a control message input module, which serves as a user-operated input interface to input various control messages to the program-controlled system startup management interface;
a user login module, which is capable of being activated in response to a startup triggering event to display a user login interface on the display module for receiving a set of user authorization data from a user-initiated login event and checking whether the received user authorization data is valid; and if YES, capable of issuing a startup management enabling message;
an operation mode selection module, which is capable of being activated in response to the startup management enabling message from the control message input module to display an operation mode selection interface on the display module to show a list of operation mode options for user-selection, and which is further capable of issuing a corresponding operation mode enabling message based on a user-selected operation mode from a user-initiated operation mode selection event through the operation mode selection interface; and
a startup activating module, which is capable of being activated in response to each different operation mode enabling message to activate the computer platform to undergo a corresponding operational procedure.

2. The program-controlled system startup management interface of claim 1, wherein the computer platform is a network server.

3. The program-controlled system startup management interface of claim 1, wherein the computer platform is a network workstation.

4. The program-controlled system startup management interface of claim 1, wherein the computer platform is a desktop computer.

5. The program-controlled system startup management interface of claim 1, wherein the display module is an LCD (Liquid Crystal Display) unit.

6. The program-controlled system startup management interface of claim 1, wherein the control message input module is a matrix keyboard.

7. The program-controlled system startup management interface of claim 1, wherein the startup activating module is a BMC (Baseboard Management Controller) based functional unit in an IPMI (Intelligent Platform Management Interface) compliant server management interface.

8. The program-controlled system startup management interface of claim 1, wherein the options of operation modes offered by the operation mode selection module include a power-on operation mode, a power-off operation mode, and a reset operation mode.

9. The program-controlled system startup management interface of claim 1, further comprising:
an operating system selection module, which is capable of displaying an operating system selection interface showing a group of operating system options on the display module for user-selection of a desired operating system therefrom, and which is further capable of activating the booting of the computer platform with the user-selected operating system.
